(19) United States
(12) Patent Application Publication
(10) Pub. No.: US 2009/0060381 A1
(43) Pub. Date: Mar. 5, 2009

(54) DYNAMIC RANGE AND AMPLITUDE CONTROL FOR IMAGING

(75) Inventor: Robert J. Dunki-Jacobs, Mason, OH (US)

Correspondence Address: THOMPSON HINE L.L.P.;Intellectual Property Group, P.O. BOX 8801, DAYTON, OH, 45401-8801, US

(73) Assignee: Ethicon Endo-Surgery, Inc., Cincinnati, OH (US)

(21) Appl. No.: 11/848,654

(22) Filed: Aug. 31, 2007

(51) Int. Cl. G06K 9/40; G01J 1/32

(52) U.S. Cl. 382/275; 250/590

(57) ABSTRACT

Systems and methods that enhance imaging by reducing artifacts and providing for dynamic range control. In aspects, the beam of illumination generated by a scanned beam imaging system can be modulated to offset fluctuations in the beam source. In other aspects, an image frame generated by a scanned beam imager can be used to predict whether pixels in future frames are likely to be over or under illuminated. The light source, beam of illumination and/or detectors can be adjusted on a pixel by pixel basis to compensate. In further aspects, localized gamma correction can be used to map image data to a display means. A plurality of regions are defined, such that separate gamma functions or values can be assigned to individual regions of the image.

### FIELD OF INVENTION

The systems and methods described herein relate to improvements in imaging. More particularly, systems and methods for increasing dynamic range and mitigating artifacts in imaging systems, such as scanned beam imagers.

### BACKGROUND OF THE INVENTION

Imaging devices are used in a variety of applications; in particular medical imaging is critical in the identification, diagnoses and treatment of a variety of illnesses. Imaging devices, such as a Scanned Beam Imaging device (SBI) can be used in endoscopes, laparoscopes and the like to allow medical personnel to view, diagnose and treat patients without performing more invasive surgery. To be effective, such images are required to be accurate and relatively free of artifacts. In addition, the imaging system is required to have the light intensity range resolution to allow different tissue and the like to be distinguished. Such systems should not only detect a wide dynamic range of input light intensity, but should have sufficient range to manipulate or present the received data for further processing or display. Accordingly, the analog to digital (A/D) converters and internal data paths should have sufficient resolution to represent variations in light intensity, as well as the detectors that receive light. Effectiveness of imaging systems may also be limited by the resolution of the display media (e.g., CRT/TV, LCD or plasma monitor). Generally, such display media have limited intensity range resolution, such as 256:1 (8 bit) or 1024:1 (10 bit), while the SBI device may have the ability to capture large intensity range resolutions, such as 16384:1 (14 bits) or better.

In SBI devices, instead of acquiring an entire frame at one time, the area to be imaged is rapidly scanned point-by-point by an incident beam of light. The reflected or returned light is picked up by sensors and translated into a data stream representing the series of scanned points and associated returned light intensity values. Unlike charge coupled device (CCD) imaging, where all or half of the pixels are imaged simultaneously, each scanned point in an SBI image is temporally displaced in time from the previously scanned point.

Scanned beam imaging endoscopes using bi-sinusoidal and other scanning patterns are known in the art; see, for example U.S. Patent Application US 2005/0020926 A1 to Wikloff et al. An exemplary color SBI endoscope has a scanning element that uses dichroic mirrors to combine red, green and blue laser light into a single beam of white light that is then deflected off a small mirror mounted on a scanning biaxial MEMS (Micro Electro Mechanical System) device. The MEMS device scans a given area with the beam of white light in a predetermined bi-sinusoidal or other comparable pattern and the reflected light is sampled for a large number of points by red, green and blue sensors. Each sampled data point is then transmitted to an image processing device.

### SUMMARY

The following summary provides a basic description of the subject matter described herein. It is not an overview of the subject matter. Furthermore, it does not define or limit the scope of the claimed subject matter. The sole purpose is to provide an introduction and/or basic description of certain aspects.

The systems and methods are described herein can be used to enhance imaging by reducing artifacts and providing for dynamic range control. In certain embodiments, a modulator is used in conjunction with a scanned beam imaging system to mitigate artifacts caused by power fluctuations in the system light source. The system can include a detector that receives the scanning beam from the illuminator and an analysis component that determines the difference, if any, between the emitted scanning beam and the desired scanning beam. The analysis component can utilize the modulator to adjust the scanning beam, ensuring consistency in scanning beam output.

In an alternative embodiment, the modulator can be used to accommodate the wide dynamic range of a natural scene and represent the scene in the limited dynamic range of the display media. In scanned beam imaging, a beam reflected from a field of view is received at a detector and used to generate corresponding image data. An image frame obtained using a scanned beam imager can be used to predict whether a particular location or pixel will appear over or under illuminated for display of future image frames. Based upon such predictions, the modulator can adjust the beam emitted by the illuminator on a pixel by pixel basis to compensate for locations predicted to have low or high levels of illumination. In a further embodiment, the light source or sensitivity of the detectors can be adjusted, instead of utilizing a modulator.

In still another embodiment, localized gamma correction can be used to enhance image processing. Frequently, data is lost due to limitations of display medium and the human visual system. In many systems, image data is collected over a larger range of intensities than can be displayed by the particular display means. In such systems, image data is mapped to a display range. This mapping function is often referred to as the “gamma” correction, where a single gamma function is used for an image. Here, a plurality of regions are defined, such that separate gamma functions or values can be assigned to individual regions of the image.

### BRIEF DESCRIPTION OF THE DRAWINGS

The accompanying figures depict multiple embodiments of the systems and methods described herein. A brief description of each figure is provided below. Elements with the same reference numbers in each figure indicate identical or functionally similar elements. Additionally, as a convenience, the left-most digit(s) of a reference number identifies the drawing in which the reference number first appears.

FIG. 1 is a schematic illustration of a scanned beam imager known in the art from Published Application 2005/0020926A1.

FIG. 2 is a block diagram an embodiment of an SBI system that performs beam leveling in accordance with aspects of the subject matter described herein.

FIG. 3 is a flowchart illustrating an exemplary methodology for compensating for illuminator fluctuations in accordance with aspects of the subject matter described herein.

FIG. 4 is a block diagram of an exemplary imaging system that performs automatic gain control in conjunction with scanned beam imager in accordance with aspects of the subject matter described herein.

FIG. 5 is a flowchart illustrating a methodology for performing automatic gain control in conjunction with a scanned beam imager in accordance with aspects of the subject matter described herein.

FIG. 6 is a block diagram of an exemplary imaging system that performs automatic gain control and beam leveling in conjunction with a scanned beam imager in accordance with aspects of the subject matter described herein.

FIG. 7 is a block diagram of a further embodiment of an imaging system that performs automatic gain control in accordance with aspects of the subject matter described herein.

FIG. 8A and 8B illustrate exemplary gamma correction functions in accordance with aspects of the subject matter described herein.

FIG. 9 is a block diagram of an exemplary imaging system that utilizes localized gamma correction in accordance with aspects of the subject matter described herein.

FIG. 10 is a flowchart illustrating an exemplary methodology for localized gamma correction in accordance with aspects of the subject matter described herein.

FIG. 11 is a representation of a model for spatially filtered localized gamma correction in accordance with aspects of the subject matter described herein.

FIG. 12 is a flowchart illustrating an exemplary methodology for localized gamma correction utilizing the elastic sheet model to filter gamma values in accordance with aspects of the subject matter described herein.

### DETAILED DESCRIPTION

It should be noted that each embodiment or aspect described herein is not limited in its application or use to the details of construction and arrangement of parts and steps illustrated in the accompanying drawings and description. The illustrative embodiments of the claimed subject matter may be implemented or incorporated in other embodiments, variations and modifications, and may be practiced or carried out in various ways. Furthermore, unless otherwise indicated, the terms and expressions employed herein have been chosen for the purpose of describing the illustrative embodiments for the convenience of the reader and are not for the purpose of limiting the subject matter as claimed herein.

It is further understood that any one or more of the following-described embodiments, examples, etc. can be combined with any one or more of the other following-described embodiments, examples, etc.

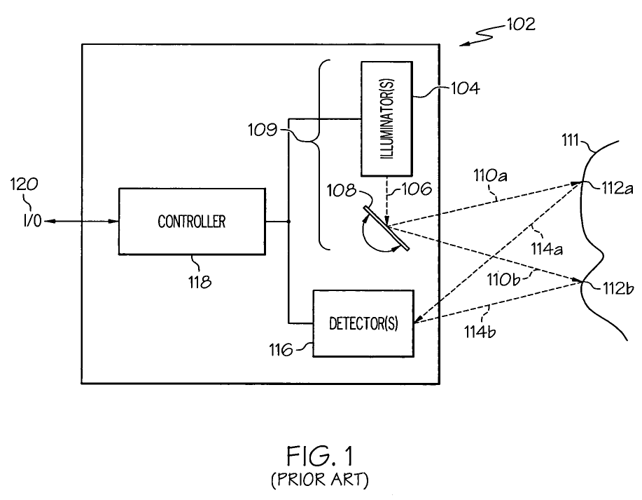

FIG. 1 shows a block diagram of one example of a scanned beam imager 102 as disclosed in U.S. Published Application 2005/0020926A1. This imager 102 can be used in applications in which cameras have been used in the past. In particular it can be used in medical devices such as video endoscopes, laparoscopes, etc. An illuminator 104 creates a first beam of light 106. A scanner 108 deflects the first beam of light across a field-of-view (FOV) to produce a second scanned beam of light 110, shown in two positions 110a and 110b. The scanned beam of light 110 sequentially illuminates spots 112 in the FOV, shown as positions 112a and 112b, corresponding to beam positions 110a and 110b, respectively. While the beam 110 illuminates the spots 112, the illuminating light beam 110 is reflected, absorbed, scattered, refracted, or otherwise affected by the object or material in the FOV to produce scattered light energy. A portion of the scattered light energy 114, shown emanating from spot positions 112a and 112b as scattered energy rays 114a and 114b, respectively, travels to one or more detectors 116 that receive the light and produce electrical signals corresponding to the amount of light energy received. Image information is provided as an array of data, where each location in the array corresponds to a position in the scan pattern. In one embodiment, the output 120 from the controller 118 may be processed by an image processor (not shown) to produce an image of the field of view. In another embodiment, the output 120 is not necessarily processed to form an image but may be fed to a controller to control directly a therapeutic treatment such as a laser. See, for example, U.S. application Ser. No. 11/615140 (Attorney's docket END5904).

The electrical signals drive an image processor (not shown) that builds up a digital image and transmits it for further processing, decoding, archiving, printing, display, or other treatment or use via interface 120. The image can be archived using a printer, analog VCR, DVD recorder or any other recording means as known in the art.

Illuminator 104 may include multiple emitters such as, for instance, light emitting diodes (LEDs), lasers, thermal sources, arc sources, fluorescent sources, gas discharge sources, or other types of illuminators. In some embodiments, illuminator 104 comprises a red laser diode having a wavelength of approximately 635 to 670 nanometers (nm). In another embodiment, illuminator 104 comprises three lasers: a red diode laser, a green diode-pumped solid state (DPSS) laser, and a blue DPSS laser at approximately 635 nm, 532 nm, and 473 nm, respectively. Illuminator 104 may include, in the case of multiple emitters, beam combining optics to combine some or all of the emitters into a single beam. Illuminator 104 may also include beam-shaping optics such as one or more collimating lenses and/or apertures. Additionally, while the wavelengths described in the previous embodiments have been in the optically visible range, other wavelengths may be within the scope of the claimed subject matter. Emitted beam 106, while illustrated as a single beam, may comprise a plurality of beams converging on a single scanner 108 or onto separate scanners 108.

In a resonant scanned beam imager (SBI), the scanning reflector or reflectors 108 oscillate such that their angular deflection in time is approximately a sinusoid. One example of these scanners 108 employs a microelectromechanical system or (MEMS) scanner capable of deflection at a frequency near its natural mechanical resonant frequencies. This frequency is determined by the suspension stiffness, and the moment of inertia of the MEMS device incorporating the reflector and other factors such as temperature. This mechanical resonant frequency is referred to as the “fundamental frequency.” Motion can be sustained with little energy and the devices can be made robust when they are operated at or near the fundamental frequency. In one example, a MEMS scanner 108 oscillates about two orthogonal scan axes. In another example, one axis is operated near resonance while the other is operated substantially off resonance. Such a case would include, for example, the non-resonant axis being driven to achieve a triangular, or a sawtooth angular deflection profile as is commonly utilized in cathode ray tube (CRT)—based video display devices. In such cases, there are additional demands on the driving circuit, as it must apply force throughout the scan excursion to enforce the desired angular deflection profile, as compared to the resonant scan where a small amount of force applied for a small part of the cycle may suffice to maintain its sinusoidal angular deflection profile.

In accordance with certain embodiments, scanner 108 is a MEMS scanner. MEMS scanners can be designed and fabricated using any of the techniques known in the art as summarized in the following references: U.S. Pat. No. 6,140,979, U.S. Pat. No. 6,245,590, U.S. Pat. No. 6,285,489, U.S. Pat. No. 6,331,909, U.S. Pat. No. 6,362,912, U.S. Pat. No. 6,384,406, U.S. Pat. No. 6,433,907, U.S. Pat. No. 6,512,622, U.S. Pat. No. 6,515,278, U.S. Pat. No. 6,515,781, and/or U.S. Pat. No. 6,525,310, all hereby incorporated by reference. In one embodiment, the scanner 108 may be a magnetically resonant scanner as described in U.S. Pat. No. 6,151,167 of Melville, or a micromachined scanner as described in U.S. Pat. No. 6,245,590 to Wine et al. In an alternative embodiment, a scanning beam assembly of the type described in U.S. Published Application 2005/0020926A1 is used.

In an embodiment, the assembly is constructed with a detector 116 having adjustable gain or sensitivity or both. In one embodiment, the detector 116 may include a detector element (not shown) that is coupled with a means for adjusting the signal from the detector element such as a variable gain amplifier. In another embodiment, the detector 116 may include a detector element that is coupled to a controllable power source. In still another embodiment, the detector 116 may include a detector element that is coupled both to a controllable power source and a variable gain or voltage controlled amplifier. Representative examples of detector elements useful in certain embodiments are photomultiplier tubes (PMT's), charge coupled devices (CCD's), photodiodes, etc.

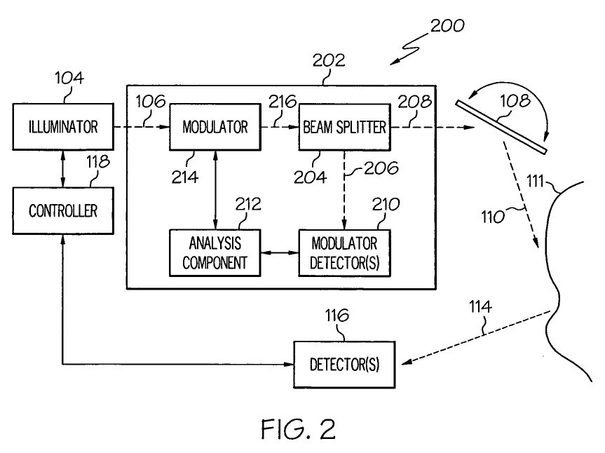

Referring now to the block diagram of an embodiment of an SBI system 200 with beam leveling, depicted in FIG. 2, the system 200 is similar to the scanned beam imager system 102 of FIG. 1, with the addition of a modulation system 202. Generally, imaging system performance is affected by the quality and reliability of the illuminator or illuminators 104 used. Fluctuations in the emitted beam may be misinterpreted as changes to the scene located within the field of view. Such temporal fluctuations in illuminator(s) 104 may introduce one or more artifacts into the images generated by the imaging system. For example, laser sources, while appearing stable to the unaided eye, often contain power level fluctuations that are sufficient to create artifacts in a scanned beam imager utilizing laser source illuminators. Such artifacts are not necessarily correlated with the image and may be interpreted as noise, reducing the signal to noise ratio (SNR) of the imaging system and quality of the resulting images. In general, there are two distinct types of fluctuations in power or intensity of illuminators. In the first type, a relatively gradual increase or decrease in power over time results in the image gradually becoming more or less intensely illuminated. In the second type, more rapid fluctuations can cause bright or dark spots within an image. Either effect is undesirable, particularly in critical uses, such as medical imaging. Typically, less expensive illuminators are more likely to have greater fluctuations than more expensive illuminators. Consequently, the greater the precision required in the imaging system, the greater the expense.

Turning again to FIG. 2, an exemplary SBI system 200 utilizing modulation of the emitted beam to control illuminator fluctuations, is illustrated. As used herein, the term “exemplary” indicates a sample or example. It is not indicative of preference over other aspects or embodiments. As described with respect to FIG. 1, the SBI system 200 includes one or more illuminators 104 that emit a beam of illumination 106. The scanner 108 deflects the beam of light across a field of view to produce a second scanned beam of light 110 which sequentially illuminates spots in the field of view. The illuminating light beam is reflected, absorbed, scattered, refracted, or otherwise affected by the object or material in the field of view to produce scattered light energy. A portion of the scattered light energy 114 travels to one or more detectors 116 that receive the light. The detectors 116 produce electrical signals corresponding to the amount of light received. The electrical signals are transmitted to the controller 118 and an image processor (not shown).

The system 200 includes a modulation system 202 capable of compensating for power fluctuations in the illuminators 104. A separate modulation system 202 can be utilized to compensate for each illuminator 104 within the imaging system 200. In an embodiment, the modulation system includes a beam splitter 204 that splits the beam 106 emitted from the illuminator 104. In an embodiment, the beam splitter 204 is capable of diverting a portion of the beam of light 206 for analysis by the modulation system 202, while the remainder of the beam 208 is received at the scanner 108. Representative examples of beam splitters include polarizing beam splitter (e.g., a Wollaston prism using birefringent materials), a half-silvered mirror, and the like. The diverted beam 206 is deflected and travels to one or more modulation detectors 210 that receive the light. Modulation detectors 210 can include detector elements (not shown) that generate an electrical signal corresponding to the received beam. Representative examples of detector elements useful in certain embodiments are photomultiplier tubes (PMT's), charge coupled devices (CCD's), photodiodes, and the like.

The analysis component 212 receives the electrical signals and determines whether modulation of the beam is necessary, as well as the amount of any modulation. As used herein, the term “component” can include hardware, software, firmware or any combination thereof. The analysis component 212 compares the electrical signals that correspond to the beam of illumination 206 received at the modulation detector(s) 210, to a target level that corresponds to the desired output of the illuminator 104.

In an embodiment, the target level is a predetermined constant determined based, at least in part, upon the type or model of the illuminator 104. Alternatively, the target level can be initialized by detecting the beam at an initialization time, where the target level corresponds to the state of the beam at such time. Initialization can occur automatically at or after power on of the illuminator 104. In an embodiment, a user can elect initialization of the modulation system 202 at any point, setting the target level based upon the beam emitted at that particular point in time.

Based upon comparison of the current signal and the target level, the analysis component 212 determines that appropriate modulation to achieve the target level. The analysis component 212 directs the modulator 214 to modulate the beam 106 to produce a modulated beam 216 corresponding to the target level. In an embodiment, the analysis component 212 includes an analog comparator that compares the received signal and the target level, a processor that runs a control algorithm that determines the necessary modulation of the beam based upon the comparison and a modulator driver that controls the modulator(s) 214 based upon the computed modulation. In yet another embodiment, the analysis component 212 controls operation of the modulation detector(s) 210.

In an embodiment, the modulator 214 is implemented with a silicon-based electro-optic modulator (EOM). An EOM is an optical device which can modulate a beam of illumination in phase, frequency, amplitude or direction. Representative examples of devices for modulation include birefringent crystals (e.g., lithium niobate), an etalon and the like. The modulator 214 can be integrated into a single, monolithic MEMS device, enabling integration of a modulation system 202 with polychromatic laser sources as used in SBI systems. If a polychromatic source including multiple illuminators is used, the output of each illuminator 104 would be adjusted by a separate modulation system 202 or control loop, and the output of all of the modulation systems 202 would be passed on to the scanner. In an embodiment, the modulator 214 has a contrast ratio of greater than twenty to one (20:1) at modulation frequencies over 1 gigahertz and using relatively low voltage control signals, such as less than five volts (5V). In another embodiment, the modulator has a modulation frequency of greater than about one hundred Megahertz (100 MHz).

In certain embodiments, the sampling rate of the modulation system 202 can be significantly higher than the imaging rate of the scanned beam imager. Generally, SBI imagers sample reflected illumination at a rate of about fifty (50) million samples per second (MSPS). The speed of the modulation can be greater than 100 Megahertz (MHz), allowing the output power of the illuminator(s) 104 to be leveled before artifacts appear in images generated by the imaging system 200.

In a further embodiment, the beam of illumination produced by the illuminator 104 passes through an optic fiber (not shown) prior to reaching the scanner 108. For example, an SBI system implemented in an endoscope utilizes fiber optics to allow the beam to be transmitted into a body. An SBI system can be easily modified by positioning the beam splitter 204 between the illuminators 104 and the optic fiber. If beams from multiple illuminators 104 are used to generate polychromatic light, a beam splitter 204 capable of separating the polychromatic light into multiple beams (e.g., a dichroic mirrored prism assembly) can be used and the beams can be individually modulated.

In an endoscope utilizing an SBI system, the illuminator 104 is positioned exterior to the body and the beam passes through an optic fiber until reaching the scanner 108, positioned proximate to the tip of the endoscope inside the body. As the beam is transmitted along the optic fiber, beam intensity may be lost. The magnitude of the loss can be affected by relative curvature of the optic fiber. In an embodiment, the beam splitter 204 and modulator detectors 210 are positioned proximate to the scanner 108, such that the modulator 214 compensates for any loss in power due to the current position or curvature of the optic fiber. In another embodiment, a beam splitter 204 is positioned proximate to the scanner 108 and the diverted beam can be transmitted through a second optic fiber to modulator detectors 214 positioned exterior to the body. In a further embodiment, a second beam splitter (not shown), such as a dichroic mirrored prism assembly, can split the beam from the second optic fiber into multiple beams (e.g., red, blue and green), which can be received and processed by separate modulator detectors 214. Any power loss at the scanner 108 can be computed based upon total loss received at the modulator detector 214. This configuration may be particularly useful in an endoscope, where minimization of the components inserted into the body is critical.

Various aspects described herein can be implemented in a computing environment and/or utilizing processing units. For example, the analysis component 212 as well as various other components can be implemented using a microprocessor, microcontroller, or central processor unit (CPU) chip and printed circuit board (PCB). Alternatively, such components can include an application specific integrated circuit (ASIC), programmable logic controller (PLC), programmable logic device (PLD), digital signal processor (DSP), or the like. In addition, the components can include and/or utilize memory, whether static memory such as erasable programmable read only memory (EPROM), electronically erasable programmable read only memory (EEPROM), flash or bubble memory, hard disk drive, tape drive or any combination of static memory and dynamic memory. The components can utilize software and operating parameters stored in the memory. In some embodiments, such software can be uploaded to the components electronically whereby the control software is refreshed or reprogrammed or specific operating parameters are updated to modify the algorithms and/or parameters used to control the operation of the modulator 214, illuminator 104 or other system components.

Flowcharts are used herein to further illustrate certain exemplary methodologies associated with image enhancement. For simplicity, the flowcharts are depicted as a series of steps or acts. However, the methodologies are not limited by the number or order of steps depicted in the flowchart and described herein. For example, not all steps illustrated may be necessary for the methodology. Furthermore, the steps may be reordered or performed concurrently, rather than sequentially as illustrated.

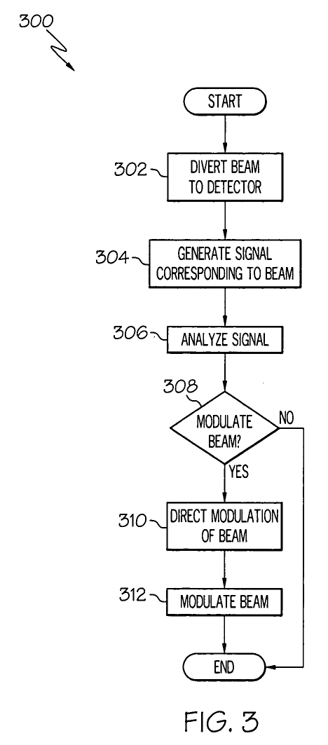

Turning now to FIG. 3, a flowchart illustrating an exemplary methodology 300 for compensating for illuminator fluctuations or beam leveling is depicted. At reference number 302, a beam of illumination emitted by an illuminator 104 is diverted to a modulator detector 210. In particular, a beam splitter 204 is used to divert a portion of the beam. At reference number 304, an electrical signal is generated corresponding to the received beam of illumination. In an alternative embodiment, the beam can be sampled using an optic sampler that generates an electrical signal corresponding to the intensity of the received beam. The signal is analyzed at reference number 306 to determine if modulation of the beam of illumination is necessary. In particular, the electrical signal is compared with a target level that corresponds to a desired intensity of the beam. In an embodiment, the desired beam intensity, and therefore the target level, is constant. For example, the target level can be a predetermined constant or may be initialized after power on of the illuminator 104. In a further embodiment, the desired beam intensity, and its corresponding target level, varies based upon user input, automatic adjustment or any other factors.

At reference number 308, a determination is made as to whether the beam of light requires modulation based at least in part upon the comparison of the signal to the target level. If no, the process ends and modulator 214 is left in its then current state. If yes, at reference number 310,, the necessary direction or command is transmitted to the modulator 214 to modify the beam. At reference number 312, the modulator 214 affects the beam, such that the beam received at the scanner 108 is modulated to compensate for any changes in the beam emitted by the illuminator 104.

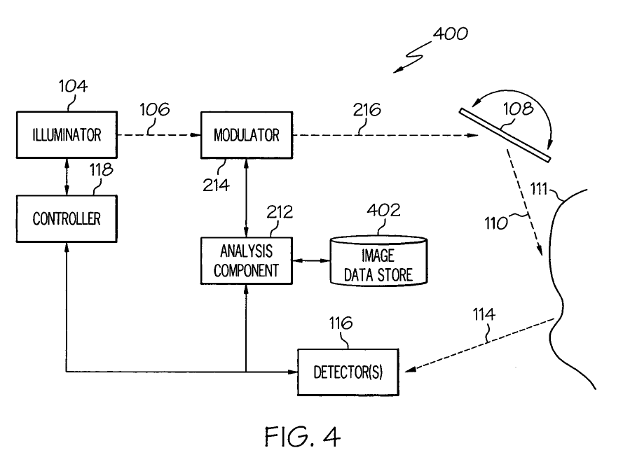

Referring now to FIG. 4, an exemplary imaging system 400 that performs automatic gain control in conjunction with scanned beam imaging is illustrated. The system 400 includes SBI components such as an illuminator 104, a scanner 108, a detector 116 and a controller 118, which function in a similar manner to those described with respect to FIGS. 1 and 2. In addition, the system 400 is able to dynamically modulate the beam emitted by the illuminator(s) 104 to improve imaging.

In general, imaging systems have a limited dynamic range, where dynamic range is equal to the ratio of the returned light at the detector at the saturation level to the returned light at a level perceptible above the system noise of the detector circuits. This limited range limits the ability to discern detail in either brightly reflecting or dimly reflecting areas. In particular, in SBI imaging, bright regions are most often the result of specular reflections or highly reflective scene elements close to the tip of the SBI imager. Dark regions are most often the result of optically dark or absorbing field of view elements, such as blood, distant from the tip of the SBI imager. At the extremes, the image appears to be either over or under exposed.

In many imaging systems, such as charge coupled device (CCD) imaging, all or half of the pixels are imaged simultaneously. Consequently, illumination is identical for all or half of the pixels within the image. However, in SBI devices, instead of acquiring an entire frame at one time, the area to be imaged is rapidly scanned point-by-point by an incident beam of light. As used herein, the term “frame” is equal to the set of image data for the area to be imaged. Consequently, the intensity of illumination can vary from between pixels within the same image. The reflected or returned light is picked up by sensors and translated into a data stream representing the series of scanned points and associated returned light intensity values. To improve imaging at extremes, the beam emitted by the illuminator 104 can be modulated to add illumination intensity in areas where the field of view is dark or under-exposed and to reduce illumination in areas where the field of view is bright or appears over-exposed.

Turning once again to FIG. 4, the system 400 includes a modulator 214 capable of modulating the beam output by the illuminator 104. In an embodiment, the modulator 214 is implemented using an electro-optical modulator, as described above. In operation, the electrical signal produced by the detectors 116 and corresponding to the intensity of the beam as reflected by objects 111 in the field of view and received at the detector(s) 116, can be analyzed by an analysis component 212. In certain embodiments, the analysis component 212 can be implemented within the controller 118 of a scanned beam imager.

In certain embodiments, the analysis component 212 records image data associated with the coordinates of the current pixel or location in an image frame in an image data store 402. As used herein, the term “data store” means any collection of data, such as a file, database, cache and the like. The image data includes the intensity information and data regarding any modulation applied to the beam as emitted by the illuminator 104 to obtain the current electrical signal. This image data can be used determine whether any modulation adjustment is necessary for the pixel or location for the next frame of image data. Typically, data changes slowly over successive image frames. Therefore, image data from the current frame can be used to adjust illumination for the next image frame.

When scanning the next frame of image data, the analysis component 212 can retrieve the electrical signal and modulation information for the current location to be scanned, referred to herein as the scanning location. The analysis component 212 compares the electrical signal to one or more threshold values to determine whether any further modulation is to be applied to the beam, or whether the current level of modulation is sufficient. For example, if the signal indicates that the reflected beam is of low intensity, the emitted beam can be modulated to increase intensity. Conversely, if the signal indicates that the reflected beam is of high intensity, the emitted beam can be modulated to decrease intensity the next time the location (x, y) is scanned. If the signal indicates that the reflected beam is of an acceptable intensity, the previous level of modulation can be applied to the beam. In an alternative embodiment, the electrical signal and modulation value for the location just scanned can be used to set values for the next location.

The modulation system 400 is capable of performing localized automatic gain control, synchronized with the particular requirements of the field of view. If a set of illuminators are utilized, such as a red, blue and green laser, multiple modulators can be used, each modulating a separate illuminator. In an embodiment, a separate modulator 214 is utilized for each laser component of the illuminators.

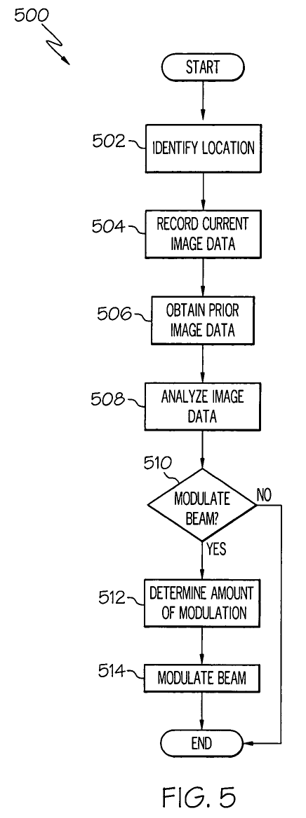

FIG. 5 is a flowchart illustrating a methodology 500 for performing localized gain control. At reference number 502, the current scanning location (x, y) is identified. The current image data is recorded in an image data store 402 at reference number 504. In an embodiment, image data includes the electrical signal generated by the detector(s) corresponding to the intensity of the reflected beam of illumination received at the detector and any modulation currently applied to the beam emitted from the illuminator. This image data can be used to determine what if any modulation is to be applied for that scanning location in future image frames. Since the difference between successive image frames is generally slight, the image data collected in previous frames can be used to predict-intensity in future frames.

Based upon such coordinates, the image data for that location in a previous frame is obtained at reference number 506. Image data includes intensity information and data regarding any modulation applied to achieve such intensity. At reference number 508, the retrieved image data is analyzed. In particular, the intensity information is compared to one or more thresholds to determine whether the location was over or under exposed in the previous frame. In an embodiment, the thresholds are predetermined constants. In another embodiment, thresholds can be determined based upon user input.

At reference number 510, a determination is made as to whether the beam is to be modulated for the current scan location based upon the analysis of the previous information. The determination is based upon comparison of intensity information to the thresholds and the record of prior modulation of the beam. For example, the intensity from the previous image may be within the acceptable range, indicating that the location was sufficiently illuminated without being excessively illuminated. However, the modulation information may indicate that to achieve that intensity, the modulator 214 modified the emitted beam. Accordingly, the same modulation should be utilized in the current scan of the location.

If no modulation is required, the process terminates and no additional direction is provided to the modulator 214. If yes, direction or controls for the modulator 214 are generated at reference number 512 and at reference number 514, the beam emitted from the illuminator is modulated. The methodology 500 is-repeated for successive locations in an image frame, automatically performing gain control.

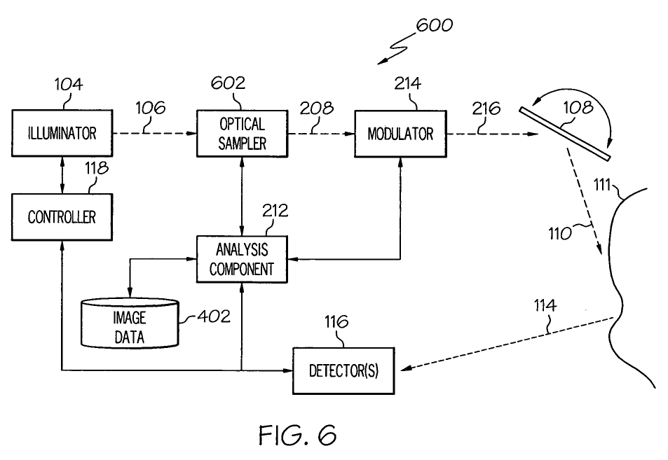

FIG. 6 illustrates an exemplary imaging system 600 that performs beam leveling as well as automatic gain control. The system 600 is capable of adjusting for fluctuations in the illuminator(s) 104 as well as for limitations in dynamic range of scanned beam imagers. The system 600 includes a modulator 214 as described above with respect to FIGS. 2 and 4. An optical sampler 602 is used to generate an electrical signal that corresponds to the beam 106 emitted from the illuminator 104. In another embodiment, the optical sampler 602 can be implemented by a beam splitter and one or more detectors, or any equivalent, where a beam splitter would divert a portion of the beam for analysis by a modulation detector that generates an electrical signal.

In an embodiment, an analysis component 212 receives the electrical signals from the optical sampler and determines the appropriate modulation of the beam produced by the illuminator 104. In particular, the analysis component 212 compares the electrical signals to a target level that corresponds to the desired output of the illuminator 104. Based upon this comparison, the analysis component 212 determines that appropriate modulation to achieve the target level. The analysis component 212 directs the modulator 214 to achieve this target level.

In this embodiment, the target level is not necessarily constant; instead the target level is computed to perform automatic gain control. As described above with respect to FIG. 4, image data from the previous image frame can be used to optimize modulation for the current image frame. Image data including intensity and modulation information can be recorded in the image data store 402 for each location in the image frame. The image data can then be used to determine appropriate modulation, if any, in the current image frame.

When scanning a location (x, y) to generate an image frame, the analysis component 212 can retrieve the electrical signal or intensity information and modulation information for that location from an image data store 402. The analysis component 212 can compare the retrieved electrical signal information to one or more threshold values to determine the appropriate target level for the beam. For example, if the signal information indicates that the reflected beam was of low intensity, a target level is selected such that the emitted beam is modulated to increase intensity. Conversely, if the signal indicates that the reflected beam was of high intensity, the target level is selected such that the emitted beam is modulated to decrease intensity when the location (x, y) is scanned. If the signal indicates that the reflected beam was of an acceptable intensity, no further modulation is necessary.

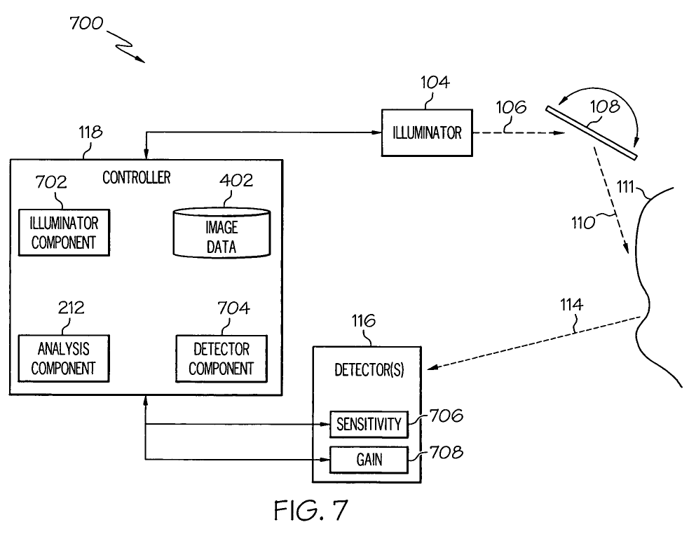

Referring now to FIG. 7, an exemplary imaging system 700 that performs dynamic range modulation is illustrated. As described with respect to FIG. 1, the imaging system 700 includes a controller 118 that directs one or more illuminators 104. In particular, the controller 118 includes an illuminator component 702 capable of regulating emission of a beam by the illuminator. The illuminators 104 emit a beam of illumination which is reflected by a scanner 108. The motion of the scanner 108 causes the beam of light to successively illuminate the field of view. The beam is reflected onto one or more adjustable detectors 116, providing information regarding the surface of objects within the field of view. The adjustable detector or detectors 116 generate an electrical signal that corresponds to the beam received at the detectors 116. The electrical signal is provided to the controller 118 for processing and becomes image data. The controller 118 includes a detector component 704 that adjusts sensitivity of the detector(s).

The controller 118 includes an analysis component 212 that evaluates the electrical signal obtained from the detector(s) and determines whether a particular location is over or under illuminated. In an embodiment, analysis is based solely upon the current data received from the detectors 116. In a further embodiment, image data can be maintained in an image data store 402 and used to predict whether a particular location will be over or under illuminated in a future image frame. Image data can include data regarding intensity of reflected beam, regulation of the illuminator 104 by the illuminator component, and adjustment of the detector 116 by the detector component 704.

The detector component 704 is operatively connected to the detector 116 to modify the detector gain through control ports, Sensitivity 706 and Gain 708. In an embodiment, the sensitivity port 706 is operably connected to a controllable power source such as a Voltage Controlled Voltage Source (VCVS) (not shown). In one embodiment the sensitivity control port 706 employs analog signaling. In another embodiment, the sensitivity control port 706 employs digital signaling. The gain port 708 is operably connected to a voltage controlled amplifier (VCA) (not shown). In one embodiment, the gain control port 708 employs analog signaling. In another embodiment, the gain control port 708 employs digital signaling. The detector component 704 apportions detector gain settings to the sensitivity and gain control ports. The detector component 704 can update settings during each detector sample period or during a small number of temporally contiguous sample periods.

In a particular detector, an APD or Avalanche Photo Diode, sensitivity can be controlled by the applied bias voltage (controlled by the VCVS). This type of gain control is relatively slow. In one embodiment, this control can best be used to adjust the gain or “brightness level” of the overall image, not individual locations within the image. Another method to control the gain is to provide a Voltage Controlled Amplifier (sometimes referred to as a Variable Gain Amplifier) just prior to sending the detector output to the A/D converter. These circuits have extremely rapid response and can be used to change the gain many times during a single oscillation of the scanning mirror.

In general, the inability to discern subtle differences in highlights and shadows is impacted most by limitations of display medium and the human visual system. In many systems, image data is collected over a larger range of intensities than can be displayed by the particular display means. In such systems, image data is mapped to a display range. This mapping function is often referred to as the “gamma” correction, which can be represented as follows:

D(x, y)=Gamma(I(x, y))

Here, I(x, y), is the intensity at coordinates (x, y) and D(x, y) is the displayed intensity. The function Gamma, may be linear or non-linear. In an embodiment, the Gamma function can be represented as follows:

y=x^{y}

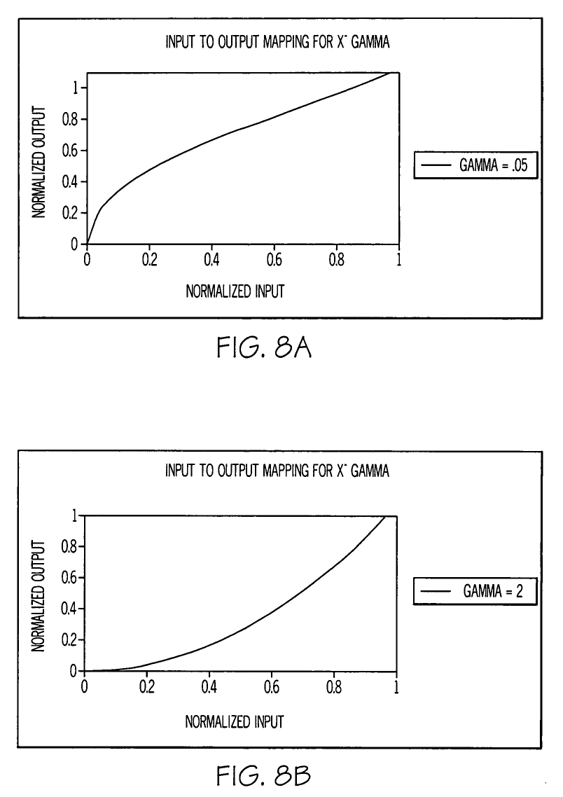

Here, x is the image intensity and y is the displayed intensity. Gamma value, γ, can be selected to optimize the displayed image. The graphs depicted in FIGS. 8A and 8B below illustrate the effect of selecting various values for Gamma.

FIG. 8A is a graph of the above Gamma function with γ=0.5. For this function, if γ<1, the areas of low intensity are mapped to a wider range of displayed intensities at the expense of compression of image data of high intensity. Minor changes in image data intensity at the low end of the scale, such as (between zero and 0.1), result in large changes in the displayed intensity. Conversely, the same magnitude of change in image data intensity at the high end of the scale (between 0.8 and 1) results in significantly less change in displayed intensity.

FIG. 8B is a graph of the above Gamma function with γ=2.0. Here, if γ>1, the areas of high intensity are mapped to a wider range of displayed intensities at the expense of compression of image data of low intensity. Minor changes in image data intensity at the high end of the scale (between 0.8 and 1.0), result in large changes in the displayed intensity, while the same changes in magnitude of intensity at the low end of the scale (between 0.0 and 0.1) cause significantly less change in displayed intensity. If gamma is equal to 1, then a linear mapping between image data and displayed image would occur. In other embodiments, the gamma function can be non-linear, a polynomial or even arbitrary.

In addition to adjusting fixed image data, gamma correction can also be applied to video or motion image processes, if the image capture medium (e.g., film, video tape, mpeg and the like) has the same fixed mapping to the display medium (e.g., projection screen, CRT, plasma screen and the like). Motion images can be treated as a series of still images, referred to as frames of a scene. Accordingly, gamma correction can be applied to each frame of a motion image.

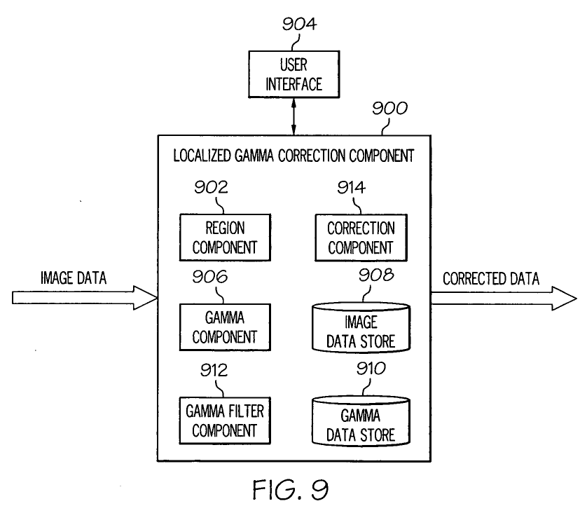

Turning now to FIG. 9, an exemplary image correction component or system 900 that utilizes localized gamma correction is depicted. The illustrated system 900 can be used independently to modify image data, or in conjunction various types of imaging systems, including, but not limited to SBI systems. Generally, during gamma correction a single gamma function or value is applied to an entire image or image frame. The image correction system 900 provides for selection of one or more regions within the image frame, such that different gamma corrections can be applied to separate regions. In this manner, regions of low intensity can utilize a gamma correction function designed to optimize mapping of low intensity image data to the output display image without negatively impacting mapping of regions with high intensity image data. Similarly, regions with high intensity image data can be optimized to map to the output display image without negatively impacting mapping of regions with low intensity image data. Use of different regions for gamma correction potentially provides for increased dynamic range and enhanced imaging.

The localized gamma correction system 900 receives or obtains image data as an input. In one embodiment, the image data includes a single image frame. In alternative embodiments, the input image data includes multiple frames of a motion image or a data stream, which is updated in real-time, providing for presentation of gamma corrected image data. A region component 902 identifies or defines two or more separate regions within an image frame for gamma correction. As used herein, a region is a portion of an image frame. Regions can be specified by listing pixels or locations contained within the region, by defining the boundaries of the region, by selection of a center point and a radius of a circular region or using any other suitable means. In an embodiment, as few as two regions are defined. In a further embodiment, each location (x, y) or pixel within the image frame is treated as a separate region and can have a separate, associated gamma function or value.

In an embodiment, the system 900 includes a user interface 904 that allows users to direct gamma correction. In one embodiment, the user interface 904 is a simple on/off control such that users can elect whether to apply gamma correction. In an alternative embodiment, the user interface 904 is implemented as a graphic user interface (GUI) that provides users with a means to adjust certain parameters and control gamma correction. For example, a GUI can include controls to turn gamma correction on and off and/or to specify different levels or magnitudes of gamma correction for each of the individual regions. In certain embodiments, the user interface 904 can be implemented using input devices (e.g., mouse, trackball, keyboard, and microphone), and/or output devices (e.g., monitor, printer, and speakers).

In a further embodiment, the region component 902 utilizes user input to determine regions for gamma correction. Users can enter coordinates using the keyboard, select points or areas on a display screen using a mouse or enter gamma correction information using any means as known in the art. The region component 902 defines regions based at least in part upon the received user input.

In another embodiment, the region component 902 automatically defines one or more regions for gamma correction based upon the input image data and/or previous image frames. In a further embodiment, the region component 902 sub-samples image data using pixel averaging or any other suitable spatial filter to create a low resolution version of the image data. Each data point in the low resolution version represents multiple pixels of image data or a region within the image data. The region component 902 detects one or more candidate regions for gamma correction using the low resolution version of the image data and one or more predetermined thresholds. For example, each data point in the low resolution version can be compared to a threshold to determine if the region represented by that data point received excessive illumination. Using a spatial locality function, the region component 902 condenses candidate regions based upon the thresholds. The identified regions or data points are then used for localized gamma correction. In an alternative embodiment, users define or modify threshold values used to automatically select regions for gamma correction. In yet another embodiment, identification of regions is performed in real time, such that regions are individually identified for each image frame as the frame is processed.

The system 900 includes a gamma component 906 that determines an appropriate gamma function or value for each region. In an embodiment, the gamma function is equal to y=x^{y}, where gamma value, γ, controls the gamma function mapping and is selected to optimize mapping of the image data to display or corrected data. The gamma component 906 can compute a gamma value for a region based upon image data associated with the region from the current frame. In a further embodiment, the gamma component 906 compares the image data for the region to one or more threshold values. For example, if the region is equal to a single location or pixel, the gamma component 906 compares the pixel value to one or more thresholds to determine if the pixel is low intensity and would therefore benefit from a low gamma value (e.g., 0.5), or if the pixel is high intensity and would therefore benefit from a high gamma value (e.g., 2.0). In yet another embodiment, if a region is composed of multiple pixels, an average, mean value or other combination of the image data for the pixels is evaluated to determine a gamma value for the region. The gamma component 906 can maintain a set of gamma values for use based upon image data.

In an alternative embodiment, the gamma component 906 utilizes image data from neighboring or proximate locations or pixels to determine an appropriate gamma value for a region. In yet another embodiment, the gamma component 906 uses a convolution kernel to determine an appropriate value. In general, convolution involves the multiplication of a group of pixels in an input image with an array of pixels in a convolution kernel. The resulting value is a weighted average of each input pixel and its neighboring pixels. Convolution can be used in high-pass (Laplacian) filtering and/or low-pass filtering.

In yet another embodiment, the gamma component 906 utilizes information regarding the image data or pixel values over time to compute gamma values. The system 900 includes an image data store 908 that maintains one or more frames of image data. In general, in a motion image or series of images obtained from an SBI or other imaging system, content of the field of view changes gradually during successive frames. Accordingly, the gamma component 906 can use a causal filter to predict future content for each location or pixel in the input image frame, based upon image data associated with the location in the previous image frame. In an embodiment, the prediction is based solely upon the contents of the particular location (x, y) for which a value is to be predicted. In another embodiment, the filter utilizes image data from proximate locations or pixels to predict content for a specific location. The gamma component 906 can utilize a temporal convolution kernel when predicting content. For example, if content changes relatively slowly, a linear predictor, such as a first derivative of the intensity curve, can be utilized. If the content varies more rapidly, second or third order filters can be used for content prediction.

The gamma component 906 determines gamma value based upon the predicted content values. For example, if it is known that the next value at an image location (x, y) is likely to be low, the gamma component 906 selects a low gamma value (e.g., 0.5) for that location, adding details to a portion of the image previously in shadow. Similarly, if it is predicted that the next value at the image location (x, y) is likely to be high, the gamma component 906 selects a high gamma value (e.g., 2.0) for that location, adding details to a highlighted area of the image.

In a further embodiment, the system 900 includes a gamma data store 910 that maintains a set of gamma values for use in gamma correction of the plurality of regions. In yet another embodiment, the set of gamma values is a matrix equal in dimension to the image data frame, such that each location (x, y) or pixel has an associated gamma value. However, basing gamma correction on small regions or even individual locations or pixels, could result in an image frame that contains artifacts. Such artifacts can be misleading, reducing the utility of the resulting image frame.

In certain embodiments, the system 900 includes a gamma filter component 912 that filters or smoothes gamma values to mitigate artifacts. The gamma filter component 912 can use convolution to decrease the likelihood of such artifacts. Artifacts may be further reduced if the two-dimensional convolution filter is expanded to three-dimensions, adding a temporal component to filtering. For example, gamma values can be adjusted based upon averaging or weighted averaging of past frames. Alternatively, the gamma filter component 912 can apply a three-dimensional convolution kernel to a temporal series of data regions.

A correction component 914 applies the gamma functions to image data to produce a corrected image or frame. Once corrected, the frame can be presented on a display medium, stored or further processed. In an embodiment, the correction component 914 retrieves the appropriate gamma value or function for each individual location (x, y) from the gamma matrix and determines the corrected image data for that location utilizing the gamma function. The corrected image seeks to optimize both the low intensity areas and the high intensity areas, enhancing the quality of the image and any imaging system. The localized gamma correction system 900 can operate in real time, updating each frame for display. The localized gamma correction component 900 can be implemented in connection with an imaging system, such as a scanned beam imager, or independently, such as in a general purpose computer.

Various aspects of the systems and methods described herein can be implemented using a general purpose computer, where a general purpose computer can include a processor (e.g., microprocessor or central processor chip (CPU)) coupled to dynamic and/or static memory. Static or nonvolatile memory includes, but is not limited to, read only memory (ROM), erasable programmable read only memory (EPROM), electronically erasable programmable read only memory (EEPROM), flash and bubble memory. Dynamic memory includes random access memory (RAM), including, but not limited to synchronous RAM (SRAM), dynamic RAM (DRAM) and the like. The computer can also include various input and output devices, such as those described above with respect to the user interface 904.

Additionally, the computer can operate independently or in a network environment. For example, the computer can be connected to one or more remotely located computers via a local area network (LAN) or wide area network (WAN). Remote computers can include general purpose computers, workstations, servers, or other common network nodes. It is to be appreciated that many additional combinations of components can be utilized to implement a general purpose computer.

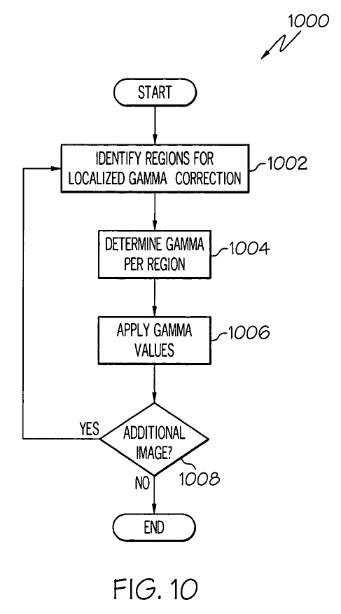

Turning now to FIG. 10, an exemplary flowchart 1000 illustrating a methodology for localized gamma correction is depicted. At reference number 1002, the region component 902 defines two or more regions for gamma correction. In an embodiment, regions are determined based upon user input. In another embodiment, the regions are selected automatically by the region component 902. In particular, the region component 902 can sample the image using a spatial filter to create a low resolution version that can be quickly analyzed. Using one or more thresholds, the region component 902 can identify candidate portions or regions of the image for localized gamma correction.

At reference number 1004, the gamma component 906 determines a gamma function or value for each region in the image frame. Gamma values can be chosen from a lookup table or calculated based upon the image data. In an embodiment, gamma values are determined based solely upon values of locations or pixels within the region. In another embodiment, gamma values are computed based at least in part upon convolution of a selected pixel and a set of proximate pixels using a convolution kernel. In a further embodiment, gamma values and/or received image data are maintained over time and used to calculate the present gamma value for a location or region. In still another embodiment, users may adjust the amount or magnitude of gamma correction via a user interface 904. The magnitude adjustment can be general and applied to all regions in the image frame, or may be specific to one or more particular regions.

The correction component 914 applies the gamma values to the image frame at reference number 1006. Application of the gamma values expands dynamic range at illumination extremes, allowing users to perceive details that might otherwise have remained hidden. At reference number 1008, a determination is made as to whether there are additional image frames to update. If no, the process terminates, if yes, the process returns to reference number 1002, where one or more regions are identified within the next image frame for localized gamma correction.

In an alternate embodiment, the process returns to reference number 1004, where gamma values are determined anew for the previously identified regions. The regions selected for localized gamma correction remain the constant between image frames, but the gamma values are updated based at least in part upon the most recent image data. For example, if a user selects specific regions for localized gamma correction, the imaging system continues to utilize the user-selected regions until the user selects different regions, turns off gamma correction, or opts for automatic region identification.

In still another embodiment, to process the next image frame, the process returns to reference number 1006, where the gamma values computed for the previous frame are applied to a new image frame. If successive image frames are similar, such that the image changes gradually over time, the gamma correction computed using the previous image frame can be used to correct the current image frame.

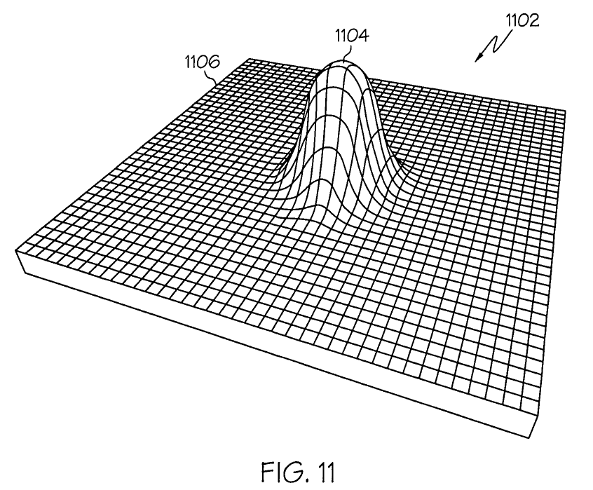

Turning now to FIG. 11, changes in contrast due to localized gamma correction can be modeled or conceptualized as an elastic sheet 1102, with the same dimensions (x, y) as the image frame. Gamma correction using a constant gamma value would be represented as a flat or planar sheet. Changes to the gamma value for a region or a single point is illustrated as a deflection from the flat, planar sheet. Without any filtering or smoothing, regions with separate gamma values would appear as jagged peaks, plateaus or canyons in the gamma representation. Such sharp transitions between gamma functions or values can lead to artifacts in an image frame. Smoothing or filtering is used to minimize the risk of such artifacts. With spatial filtering or smoothing, the sheet of gamma values transitions smoothly as shown in FIG. 11, avoiding sharp edges and the resulting image artifacts. In the exemplary gamma values for an image frame, the transition between a maximum gamma value at 1104 and the gamma value used for the bulk of the image frame 1106 is gradual.

In the elastic sheet model, elasticity and tension of the elastic sheet are constants that determine the manner in which the sheet reacts to the localized changes in gamma. Location of regions, size and direction of the changes to gamma are real-time inputs to the model. The output of the model is a matrix or set of gammas values, where gamma values vary smoothly over the image frame to optimize local dynamic range. If no local regions for gamma enhancement are specified, the model behaves as traditional gamma correction, where a single gamma value or function is applied equally across an image frame.

In an embodiment, the elastic sheet model is implemented by the gamma filter component 912 of localized gamma correction system 900 illustrated in FIG. 9. The gamma data store 910 maintains a matrix M(x, y) of gamma values. The elasticity and tension of the sheet are represented by constants Y and T, respectively. The output of the gamma filter component 912 is an enhanced gamma matrix E(x, y) of gamma values that is used for gamma correction of the image frame.

Using the elastic sheet model, the gamma filter component 912 passes the initial gamma matrix M through a two-dimensional spatial filter, such as a median filter, to arrive at the output matrix, E. The size of the two-dimensional kernel used for the spatial filter is proportional to tension constant, T, and defines the extent of the filter effect. For example, in an embodiment, the size of the two-dimensional kernel is 2T+1 by 2T+1. The overall shape of the filter is determined by the elasticity constant, Y. For example, high values for the elasticity constant can represent greater elasticity, such that a change in gamma at one point or pixel will have a relatively strong effect on a relatively small area around the point. Conversely, low values for the elasticity constant can represent lower elasticity, such that a change in gamma will have a relatively weak effect over a larger area. The filter is constructed to reflect the effects of the relative elasticity of the model. If y>1 then “light” areas are enhanced. If y<1 then “dark” areas are enhanced. If y=1 then no enhancement takes place. The further the difference from 1, the greater the enhancement effect.

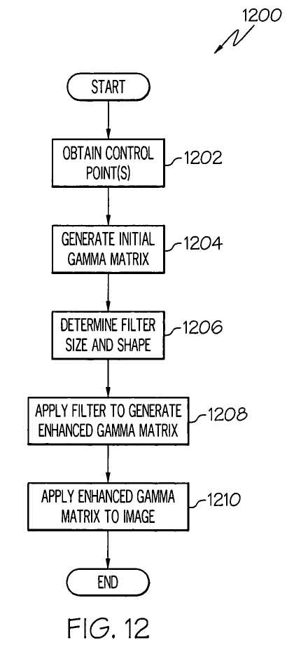

FIG. 12 is a flowchart illustrating an exemplary methodology 1200 for localized gamma correction utilizing the elastic sheet model to filter gamma values. At reference number 1202, one or more regions or control points are obtained. In an embodiment, one or more regions or control points are selected by a user utilizing a user interface 904. In another embodiment, one or more regions or control points are automatically selected based upon initial analysis of the image data. Furthermore, regions can be selected based upon a combination of user and automatic selection. For example, suggested regions may be automatically presented to a user for selection.

At reference number 1204, an initial gamma matrix, M, is generated. The initial gamma matrix is of the same dimension as the image frame and can be defaulted to a predetermined value. In an embodiment a gamma component 906 determines a gamma function or value for each region or control point in the image frame. Gamma values can be chosen from a lookup table or calculated based upon the image data. In an embodiment, gamma values are determined based solely upon values of locations or pixels within the region. In another embodiment, gamma values are computed based at least in part upon convolution of a selected pixel and a set of proximate pixels using a convolution kernel. In a further embodiment, gamma values and/or received image data are maintained over time and used to calculate the present gamma value for a location or region. In still another embodiment, users may adjust the amount or magnitude of gamma correction via a user interface 904. The magnitude adjustment can be general and applied to all regions in the image frame, or may be specific to one or more particular regions. Initial gamma matrix can be generated based upon the gamma values generated for each of the regions in the image frame.

Based upon the elastic sheet model, a filter is generated at reference number 1206. The filter size and shape are determined based upon the elasticity, Y, and tension, T, of the model. In an embodiment, the two-dimensional kernel or filter has dimensions of 2T+1 by 2T+1. The overall shape of the filter is determined by the elasticity constant, Y.

At reference number 1208, the filter is applied to the initial gamma matrix, M, smoothing the gamma values, and generating an enhanced gamma matrix, E. The enhanced gamma matrix is applied to the image frame at 1210, minimizing the number and/or effect of artifacts in the image frame.

It will be understood that the figures and foregoing description are provided by way of example. It is contemplated that numerous other configurations of the disclosed systems, processes and devices for imaging may be created utilizing the subject matter disclosed herein. Such other modifications and variations there may be made by persons skilled in the art without departing from the scope and spirit of the subject matter as defined by the appended claims.

What is claimed is:

1. An imaging system, comprising:
a detector that produces an electrical signal corresponding to a scanning beam emitted by a scanned beam imager;
an analysis component that analyzes said electrical signal with respect to a target level; and
a modulator that modulates said scanning beam based at least in part upon analysis by said analysis component to generate modulated light, such that said modulated light corresponds to said target level.

2. The system of claim 1, said modulator is an electro-optical modulator with a modulation frequency of greater than about one hundred Megahertz.

3. The system of claim 1, said target level is initialized, such that said target level corresponds to said scanning beam at an initialization time.

4. The system of claim 1, further comprising a beam splitter that directs at least a portion of said beam at said detector.

5. The system of claim 1, further comprising:
an analog comparator that compares said electrical signal to said target level; and
a processor programmed to direct said modulator.

6. A method of imaging, comprising:
receiving a beam of light from a scanned beam imager light source;
generating a signal representative of said beam of light;
comparing said signal to a value corresponding to a desired intensity for said beam of light; and
modulating intensity of said beam light as a function of comparing said signal and said value.

7. The method of claim 6, modulating said intensity of said beam of light at a frequency of greater than about one hundred megahertz.

8. A system that performs scanned beam imaging, comprising:
an image data store that maintains a frame generated by scanned beam imager;
an analysis component that obtains image data that corresponds to a current scanning location of said scanned beam imager from said frame and analyzes said image data to generate analyzed image data; and
a modulator that modulates light emitted by said scanned beam imager based at least in part upon said analyzed image data.

9. The system of claim 8, said image data includes intensity information and modulation information, the system further comprising an analog comparator that compares said intensity information to at least one predetermined threshold to generate an intensity comparison, where said modulator modulates said light as a function of said modulation information and said intensity comparison.

10. The system of claim 8, further comprising an optical sampler that samples said light emitted from said scanned beam imager to generate a sampled intensity, wherein said modulator modulates said light as a function of said sampled intensity to compensate for fluctuations in said light.

11. The system of claim 8, said modulator is an electro-optical modulator that is capable of modulating at frequencies of greater than about one hundred Megahertz.

12. A methodology for scanned beam imaging, comprising:
identifying current scanning coordinates for a scanned beam imager;
retrieving image data corresponding to said current scanning coordinates from an image frame;
processing said image data to determine the appropriate modulation of a beam of illumination emitted by said scanned beam imager; and
modulating said beam of illumination based at least in part upon said appropriate modulation.

13. The methodology of claim 12, further comprising recording said image data for use modulating said beam of illumination.

14. The methodology of claim 12, said image data including intensity data and previous modulation of said beam and said appropriate modulation is a function of a comparison of said intensity data to a predetermined threshold and said previous modulation.

15. A system that compensates performs gamma correction, comprising:
a region component that specifies a first region and a second region within an image frame;
a gamma component that determines a first gamma function associated with the first region and a second gamma function associated with the second region; and
a gamma correction component that applies said first gamma function to said first region and said second gamma function to said second region to generate a corrected image frame.

16. The system of claim 15, the region component specifies the first region and the second region as a function of analysis of said image frame.

17. The system of claim 15, the gamma component utilizes a convolution kernel to determine said first gamma value and said second gamma value.

18. The system of claim 15, said image frame is generated by a scanned beam imager and said corrected image frame is generated in real time.

19. The system of claim 15, further comprising a user interface adapted to define the first region.

20. The system of claim 19, said user interface is adapted to control magnitude of the first gamma function.

21. A system that performs gamma correction, comprising:
a control component that specifies one or more control points within an image frame;
a gamma component that generates a gamma value for said one or more control points, said gamma values are maintained in a gamma matrix of the same dimensions as said image frame;
means for filtering said gamma matrix; and
a correction component that applies said gamma matrix to said image frame.

22. The system of claim 21, said means for filtering said gamma matrix utilizes a two-dimensional convolution filter.

23. The system of claim 21, said means for filtering said gamma matrix utilizes a three-dimensional, temporal convolution filter.

24. The system of claim 21, said means for filtering performs spatial filtering.

25. A method for performing localized gamma correction, comprising:
identifying a plurality of regions of an image frame for gamma correction;
determining a gamma value for each of said plurality of regions;
applying said gamma values to each of said plurality of regions to generate a modified image frame.

26. The method of claim 25, further comprising:
applying a convolution kernel to a location in said image frame to obtain a weighted average; and
comparing said weighted average to a threshold, said gamma value is based at least in part upon said comparison.

27. The method of claim 25, further comprising applying a spatial filter to said gamma values.

28. A scanning beam assembly, comprising:
an illuminator that generates a beam of illumination;
a scanner configured to deflect said beam at varying angles to yield a scanned beam that scans a field of view;
a detector that detects light reflected from said field of view; and
a controller programmable to control intensity of said beam of illumination generated by said illuminator, said intensity is controlled based at least in part upon said light reflected from said field of view.

29. The system of claim 28, said controller is programmed to increase said intensity of said beam of illumination when intensity of said light reflected from said field of view is below a predetermined threshold.

30. The system of claim 28, said controller is programmed to decrease said intensity of said beam of illumination when intensity of said light reflected from said field of view is above a predetermined threshold.

31. The system of claim 28, further comprising an image data store that records data related to said light reflected from said field of view, said controller is programmed to utilize said data to determine said intensity of said beam of illumination.

32. A method for scanned beam imaging, comprising:
generating a beam of illumination;
deflecting said beam of illumination across a field of view;
detecting reflectance from the field of view at a detector; and
adjusting gain of said detector based at least in part upon said reflectance.

33. The method of claim 32, further comprising increasing said gain of said detector when intensity of said reflectance is below a predetermined threshold.

34. The method of claim 32, further comprising decreasing said gain of said detector when intensity of said reflectance is above a predetermined threshold.

35. The method of claim 32, further comprising:
recording said reflectance for a plurality of locations; and
predicting future reflectance for said plurality of locations based at least in part upon said reflectance.
